(19) United States
(12) Patent Application Publication
(10) Pub. No.: US 2025/0034361 A1
(43) Pub. Date: Jan. 30, 2025

(54) COMPOSITION FOR SILICONE RUBBER COMPOUNDS

(71) Applicant: Nitrochemie Aschau GmbH, Aschau am Inn (DE)

(72) Inventors: Rüdiger Schuck, Suederhasted (DE); Jörg Lippstreu, Waging am See/Tettenhausen (DE); Alexis Krupp, Waldkraiburg (DE); Thomas Knott, Mühldorf (DE); Ulrich Pichi, Aschau (DE)

(21) Appl. No.: 18/715,062

(22) PCT Filed: Nov. 24, 2022
(86) PCT No.: PCT/EP2022/083121

§ 371 Date: May 30, 2024

(30) Foreign Application Priority Data
Nov. 30, 2021 (DE) 10 2021 131 400.3

(51) Int. Cl. C08K 5/5333; C08K 3/22; C08K 5/00; C08K 5/549

(52) U.S. Cl. CPC C08K 5/5333; C08K 3/22; C08K 5/0025; C08K 5/549; C08K 2003/2237; C08K 2003/2244

(57) ABSTRACT

A curable composition comprising a polyorganosiloxane, a silane-based crosslinker, a heterocyclic azasilane and an organophosphonic acid, and a process for preparing the curable composition and its use is provided.

### BACKGROUND

The invention relates to a curable composition comprising a polyorganosiloxane, a crosslinker having suitable leaving groups and a heterocyclic azasilane and a process for preparing the curable composition and its use as a sealant, glue, coating agent, jointing material, potting compound, adhesive and in paints.

Silicone rubber compounds are materials with elastic properties and have a wide range of applications, especially in the sanitary sector and building construction, for example as sealants, jointing materials, coating agents, potting compounds and adhesives for a wide variety of materials such as glass, porcelain, ceramics, stone, plastics, metals, wood, etc. Cold-curing silicone rubber compounds are frequently used, also known as RTV (room temperature curing) silicone rubber compounds, and in particular single-component RTV silicone rubber compounds (RTV-1). These silicone rubber compounds are usually plastically deformable mixtures of polyorganosiloxanes with crosslinkable functional groups and suitable crosslinkers (hardeners), which are stored in a moisture-free environment. These mixtures crosslink under the influence of water or humidity at room temperature. This process is known as curing. Adhesion promoters are also regularly used in silicone rubber compounds. They are used in silicone rubber compounds (e.g. in sealants or adhesives) to ensure good adhesion to various substrates.

In cold-curing silicone rubber compounds, polyorganosiloxanes (silicones) with two or more crosslinkable functional groups are generally used together with polyfunctional hardeners. The α,ω-dihydroxypolyorganosiloxanes are of great importance here as difunctional polyorganosiloxanes. The crosslinking agents or hardeners often have hydrolyzable SiX groups, wherein hydrolysis releases leaving groups that allow the hardeners to be classified as acidic, neutral or basic systems. Well-known leaving groups are, for example, carboxylic acids, alcohols and oximes.

The curing, crosslinking or polymerization of RTV-1 silicone rubber compounds can be further accelerated by adding suitable catalysts. Tin compounds have proven to be advantageous catalysts here, as they have a high catalytic activity.

DE 10 2015 204 787 A1 describes curable silicone rubber compounds containing at least one polyorganosiloxane which has at least one hydroxyl group bonded to the silicon atom, at least one silane, an aminosilane and a tin compound as a catalyst. However, tin compounds have the disadvantage that they are toxic, in particular the alkyltin compounds generally used. In addition, the storage stability and adhesion to a wide range of substrates still needs to be improved.

EP 3 392 313 A1 describes curable silicone rubber compounds containing a silicone compound with two terminal hydroxyl groups, a catalyst containing a metal-siloxane-silanol(at) compound and a crosslinker containing a silane with corresponding leaving groups. In particular, the catalyst can also be tin-free. However, the storage stability and adhesion to various substrates is still in need of improvement.

EP 3 613 803 A1 describes a composition for silicone rubber compounds, wherein the composition comprises a hardener in the form of a silane with corresponding leaving groups and at least one heterocyclic organosilane.

The compositions described above are RTV-1 silicone rubber compounds that cure in the presence of atmospheric moisture at room temperature, but the storage stability of these compositions and the adhesion to various substrates still need to be improved.

The object of the invention is therefore to overcome these disadvantages and to provide a silicone rubber-based composition which cures at room temperature, has a high storage stability and exhibits good adhesion to all common materials or substrates.

### SUMMARY OF THE INVENTION

In one embodiment, the composition according to the invention comprises
(a) a polyorganosiloxane of the formula HO—(SiR^{l}R^{m}O)ₒ—H, wherein
each R^{l} and R^{m} independently represents
an optionally substituted alkyl, alkenyl or alkynyl residue;
an optionally substituted cycloaliphatic residue, aryl residue or aralkyl residue; or an optionally substituted heteroalicyclic residue or heteroaryl residue;
and o is an integer from 5 to 5000,
(b) a crosslinker having the formula Si(R)ₘ(R^{a})₄₋ₘ, wherein
each R is independently
an optionally substituted alkyl, alkenyl or alkynyl residue;
an optionally substituted cycloaliphatic residue, aryl residue or aralkyl residue; or an optionally substituted heteroalicyclic residue or heteroaryl residue;
m is an integer from 0 to 2,
each R^{a} is independently selected from the group consisting of
(b1) is a hydroxycarboxylic acid ester residue of the formula (I):

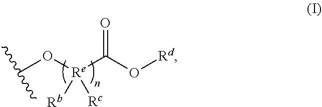

wherein
each R^{b} and R^{c} independently of each other represents
hydrogen;
an optionally substituted alkyl, alkenyl or alkynyl residue;
an optionally substituted cycloaliphatic residue, aryl residue or aralkyl residue; or an optionally substituted heteroalicyclic residue or heteroaryl residue;
   each R^{d} independently represents
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
   each R^{e} independently represents
Carbon;
an optionally substituted cycloaliphatic residue, aryl residue or aralkyl residue; or an optionally substituted heteroalicyclic residue or heteroaryl residue;
and n is an integer from 1 to 10,
(b2) is a hydroxycarboxylic acid amide residue having the formula (II):

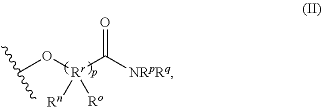

wherein
each Rⁿ, R^{o}, R^{p} and R^{q} independently of each other represents
hydrogen;
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
   R^{r} independently of each other represents
carbon;
an optionally substituted cycloaliphatic residue, aryl residue or aralkyl residue; or
an optionally substituted heteroalicyclic residue or heteroaryl residue;
and p is an integer from 1 to 10,
(b3) a carboxylic acid residue —O—C(O)—R^{f},
(b4) an oxime residue —O—N═CR^{g}R^{h}, and
(b5) to a carboxylic acid amide residue —N(Rⁱ)—C(O)—R^{j},
   wherein
each R^{f}, R^{g}, R^{h}, Rⁱ and R^{j} independently of one each other represents
hydrogen;
an optionally substituted alkyl, alkenyl or alkynyl residue;
an optionally substituted cycloaliphatic residue, aryl residue or aralkyl residue; or an optionally substituted heteroalicyclic residue or heteroaryl residue;
(c) a heterocyclic azasilane in which N and Si are ring atoms and are directly linked to each other, and
(d) an organophosphonic acid of the formula R—PO(OH)₂, wherein
R is
an optionally substituted alkyl, alkenyl or alkynyl residue,
an optionally substituted cycloaliphatic residue, aryl residue or aralkyl residue, or an optionally substituted heteroalicyclic residue or heteroaryl residue.

Surprisingly, this composition exhibits improved storage stability and improved adhesion to various plastics, wherein other essential properties of curable compositions are not negatively affected, in particular through-cure, tack-free time, full cure, transparent appearance, Shore hardness A and adhesion to various other substrates.

The heterocyclic azasilane in the curable composition according to the invention has the advantage over conventional aminosilanes in corresponding silicone rubber compounds that it only forms a ring opening in the presence of atmospheric moisture, i.e. only when the curable composition is crosslinked, and thus provides the reactive aminosilane. In this way, reactions of aminosilanes with the crosslinker and other components of the curable composition are avoided before they are exposed to atmospheric moisture. This increases the storage stability. Surprisingly, it was found that the combination of a heterocyclic azasilane and an organophosphonic acid, in particular an alkylphosphonic acid, leads to a further significant improvement in storage stability. Surprisingly, this is particularly the case when using crosslinkers which contain, for example, hydroxycarboxylic acid ester residues or hydroxycarboxylic acid amide residues, and it is particularly relevant for these crosslinkers since these contain reactive leaving groups (in particular more reactive than alkoxysilanes which contain alkoxy groups as leaving groups) and such crosslinkers generally lead to low storage stability due to the reactive leaving groups.

For the purposes of the invention, “crosslinkers” or “hardeners” are understood to mean, in particular, crosslinkable silane compounds which have at least two groups which can be split off by hydrolysis. Examples of such crosslinkable silane compounds are Si(OCH₃)₄, Si(CH₃)(OCH₃)₃ and Si(CH₃)(C₂H₅)(OCH₃)₂. Crosslinkers can also be referred to as hardeners. “Crosslinker” also includes, in particular, “crosslinker systems”, which may contain more than one crosslinkable silane compound.

“Sealants”, “sealing materials” or “sealing compounds” refer to elastic substances applied in liquid to viscous form or as flexible profiles or sheets for sealing a surface, in particular against water, gases or other media.

The term “adhesive” refers to substances that join parts by surface adhesion (adhesion) and/or internal strength (cohesion). This term includes, in particular, glue, paste, dispersion, solvent, reaction and contact adhesives.

“Coating agent” means any agent used to coat a surface.

In the context of the invention, “potting compounds” or “cable potting compounds” are hot or cold processable compounds for potting cables and/or cable accessories.

The term “alkyl group” refers to a saturated hydrocarbon residue. In particular, alkyl groups have the formula —CₙH₂ₙ₊₁. The term “C1 to C16 alkyl group” refers in particular to a saturated hydrocarbon chain with 1 to 16 carbon atoms in the chain. Examples of alkyl groups are methyl, ethyl, propyl, butyl, isopropyl, iso-butyl, sec-butyl, tert-butyl, n-pentyl and ethylhexyl. In particular, alkyl groups may also be substituted, even if this is not explicitly stated.

“Straight-chain alkyl groups” refer to alkyl groups that do not contain branches. Examples of straight-chain alkyl groups are methyl, ethyl, n-propyl, n-butyl, n-pentyl, n-hexyl, n-heptyl and n-octyl.

“Branched alkyl groups” refer to alkyl groups that are not straight-chain, i.e. in which the hydrocarbon chain in particular has a bifurcation. Examples of branched alkyl groups are isopropyl, iso-butyl, sec-butyl, tert-butyl, sec-pentyl, 3-pentyl, 2-methylbutyl, iso-pentyl, 3-methylbut-2-yl, 2-methylbut-2-yl, neopentyl, ethylhexyl and 2-ethylhexyl.

The term “alkenyl groups” refers to hydrocarbon residues that contain at least one double bond. For example, an alkenyl group with a double bond has in particular the formula —CₙH₂ₙ₋₁. However, alkenyl groups can also have more than one double bond. The term “C2 to C16 alkenyl group” refers in particular to a hydrocarbon chain with 2 to 16 carbon atoms in the chain. The number of hydrogen atoms varies depending on the number of double bonds in the alkenyl group. Examples of alkenyl groups are vinyl, allyl, 2-butenyl and 2-hexenyl.

“Straight-chain alkenyl groups” refer to alkenyl groups that do not contain any branches. Examples of straight-chain alkenyl groups are vinyl, allyl, n-2-butenyl and n-2-hexenyl.

“Branched alkenyl groups” refer to alkenyl groups that are not straight-chain, i.e. in which the hydrocarbon chain in particular has a bifurcation. Examples of branched alkenyl groups are 2-methyl-2-propenyl-, 2-methyl-2-butenyl- and 2-ethyl-2-pentenyl-.

The term “alkynyl groups” refers to hydrocarbon residues that contain at least one triple bond. For example, an alkynyl group with a triple bond has the formula —CₙH₂ₙ₋₃. Alkynyl groups can also contain more than one triple bond. Furthermore, double and triple bonds may be present. Examples are ethynyl, propynyl, butynyl or pentinyl. Alkynyl groups can be substituted or unsubstituted.

The term “aryl groups” refers to mono- or polycyclic aromatic residues. “Aromatic” refers to cyclic, planar hydrocarbons with a conjugated, aromatic π-electron system. Aryl groups are, for example, monocyclic (e.g. phenyl), bicyclic (e.g. indenyl, naphthalenyl, tetrahydronapthyl or tetrahydroindenyl) and tricyclic (e.g. fluorenyl, tetrahydroindenyl). fluorenyl, tetrahydrofluorenyl, anthracenyl or tetrahydroanthracenyl) ring systems in which the monocyclic ring system or at least one of the rings in a bicyclic or tricyclic ring system is aromatic. In particular, a C4 to C14 aryl group represents an aryl group which has 4 to 14 carbon atoms. In particular, aryl groups can also be substituted, even if this is not explicitly stated.

An aromatic group may be monocyclic, bicyclic, tricyclic or polycyclic. An aromatic group may also contain 1 to 5 heteroatoms selected from the group consisting of N, O, and S. These groups are also referred to as heteroaryl groups (see below). Examples of aromatic groups are benzene, naphthalene, anthracene, phenanthrene, furan, pyrrole, thiophene, isoxazole, pyridine and quinoline, wherein in each of the above examples the necessary number of hydrogen atoms is removed to enable incorporation into the corresponding structural formula.

A “cycloalkyl group” or a “cycloaliphatic residue” represents a mono- or polycyclic hydrocarbon residue which is not aromatic. In particular, a cycloalkyl group with 4 to 14 carbon atoms represents a non-aromatic hydrocarbon ring with 4 to 14 carbon atoms. Cycloalkyl groups can be saturated or partially unsaturated. Saturated cycloalkyl groups are not aromatic and also have no double or triple bonds. In contrast to saturated cycloalkyl groups, partially unsaturated cycloalkyl groups have at least one double or triple bond, wherein the cycloalkyl group is not aromatic. Cycloalkyl groups may in particular also be substituted, even if this is not specifically indicated.

An “aralkyl group” represents an alkyl group substituted by an aryl group. A “C5 to C15 aralkyl group” refers in particular to an aralkyl group with 5 to 15 carbon atoms, wherein both the carbon atoms of the alkyl group and the aryl group are contained therein. Examples of aralkyl groups are benzyl and phenylethyl. Aralkyl groups may in particular also be substituted, even if this is not specifically indicated.

A “cyclic ring system” refers to a hydrocarbon ring that is not aromatic. In particular, a cyclic ring system with 4 to 14 carbon atoms refers to a non-aromatic hydrocarbon ring system with 4 to 14 carbon atoms. A cyclic ring system can consist of a single hydrocarbon ring (monocyclic), of two hydrocarbon rings (bicyclic) or of three hydrocarbon rings (tricyclic). In particular, cyclic ring systems may also contain 1 to 5 heteroatoms, preferably selected from the group consisting of N, O, and S.

“Saturated cyclic ring systems” are not aromatic and also have no double or triple bonds. Examples of saturated cyclic ring systems are cyclopentane, cyclohexane, decalin, norbornane and 4H-pyran, wherein in the aforementioned examples the necessary number of hydrogen atoms is removed in each case to enable incorporation into the corresponding structural formula. For example, in a structural formula HO—R*—CH₃, wherein R* is a cyclic ring system with 6 carbon atoms, in particular cyclohexane, two hydrogen atoms would be removed from the cyclic ring system, in particular from cyclohexane, in order to allow incorporation into the structural formula.

A “heteroaryl” group, as used herein, represents a monocyclic or polycyclic aromatic ring, in particular of 5 to 10 ring atoms, wherein one, two, three or four ring atoms are nitrogen, oxygen or sulfur and the remainder is carbon. Heteroaryl groups can be substituted or unsubstituted. If they are substituted, the substituents are as defined above for cycloalkyl.

A “heteroalicyclic residue” or “heterocycloalkyl group” as used herein means a monocyclic or fused ring of 5 to 10 ring atoms containing one, two or three heteroatoms selected from N, O and S, wherein the remainder of the ring atoms is carbon. A “heterocycloalkenyl” group also contains one or more double bonds. However, the ring does not have a complete conjugated n-electron system. When substituted, the substituents are as defined above for cycloalkyl.

Unless otherwise specified, N represents in particular nitrogen. Furthermore, O represents in particular oxygen, unless otherwise specified. S represents in particular sulphur and Si represents in particular silicon, unless otherwise stated.

“Optionally substituted” means that hydrogen atoms in the corresponding group or in the corresponding residue may be replaced by substituents. In particular, substituents may be selected from the group consisting of C1 to C4 alkyl, methyl, ethyl, propyl, butyl, phenyl, benzyl, halogen, fluorine, chlorine, bromine, iodine, hydroxyl, amino, alkylamino, dialkylamino, C1 to C4 alkoxy, phenoxy, benzyloxy, cyano, nitro and thio. If a group is designated as optionally substituted, 0 to 50, in particular 0 to 20, hydrogen atoms of the group may be replaced by substituents. If a group is substituted, at least one hydrogen atom is replaced by a substituent.

“Alkoxy” represents an alkyl group that is linked to the main carbon chain via an oxygen atom.

Within the meaning of the invention, a heteroyclic azasilane is understood to be a cyclic organic compound which contains a silicon atom and a nitrogen atom each as ring atoms. In particular, it may be a 3- to 12-membered ring, preferably a 5- or 6-membered ring, particularly preferably a 5-membered ring. In the heterocyclic azasilane of the invention, Si and N are directly linked to each other. Such cyclic or heterocyclic azasilanes are also referred to as heterocyclic aminosilanes, although they are not aminosilanes, because the corresponding aminosilanes are only formed from the heterocyclic azasilanes with neighboring Si and N atoms by reaction with water through ring opening.

The term “polysiloxane” or “polyorganosiloxane” represents an organosilicone compound. A polyorganosiloxane contained in the composition is a α,ω-dihydroxyl-terminated polyorganosiloxane. In addition to homopolymeric α,ω-dihydroxyl-terminated polydiorganosiloxanes, heteropolymeric α,ω-dihydroxyl-terminated polydiorganosiloxanes with different organic substituents can also be used, wherein both copolymers of monomers with similar organic substituents on a silicon atom and copolymers of monomers with different organic substituents on a silicon atom are included, e.g. those with mixed alkyl, alkenyl and/or aryl substituents. The preferred organic substituents comprise straight-chain and branched alkyl groups with 1 to 8 carbon atoms, in particular methyl, ethyl, n- and iso-propyl, and n-, sec- and tert-butyl, vinyl and phenyl. In the individual organic substituents, individual or all carbon-bonded hydrogen atoms can be substituted by conventional substituents such as halogen atoms or functional groups such as hydroxyl and/or amino groups. For example, α,ω-dihydroxyl-terminated polydiorganosiloxanes with partially fluorinated or perfluorinated organic substituents can be used or α,ω-dihydroxyl-terminated polydiorganosiloxanes with organic substituents on the silicon atoms substituted by hydroxyl and/or amino groups are used.

Preferred examples of an organosilicone compound are α,ω-dihydroxyl-terminated polydialkylsiloxanes, such as for example α,ω-dihydroxyl-terminated polydimethylsiloxanes, α,ω-dihydroxyl-terminated polydiethylsiloxanes or α,ω-dihydroxyl-terminated polydivinylsiloxanes, and α,ω-dihydroxyl-terminated polydiarylsiloxanes, such as α,ω-dihydroxyl-terminated polydiphenylsiloxanes. Polyorganosiloxanes having a kinematic viscosity of from 5,000 to 120,000 cSt (at 25° C.) are preferred, in particular those having a viscosity of from 20,000 to 100,000 cSt, and particularly preferably those having a viscosity of from 40,000 to 90,000 cSt. Mixtures of polydiorganosiloxanes with different viscosities can also be used.

The term “material” or “sealant” as used herein describes a cured composition according to the invention.

For the purposes of the invention, “silicone rubber compounds” are synthetic silicone-containing rubber compounds which are also referred to interchangeably as curable silicone compositions in the context of the present invention, which includes rubber polymers, polycondensates, and polyadducts which can be converted to the highly elastic, cured state by crosslinking with suitable crosslinking agents. Furthermore, these are plastically mouldable mixtures, for example of α,ω-dihydroxypolyorganosiloxanen and suitable hardeners or crosslinking agents, which can be stored under exclusion of moisture, wherein these silicone rubber compounds polymerize under the influence of water or air humidity at room temperature.

The term “catalyst” means a substance that reduces the activation energy of a certain reaction and thus increases the reaction rate.

The composition may contain the compound with the formula HO—(SiR^{l}R^{m}O)ₒ—H and the crosslinker with the formula Si(R)ₘ(R^{a})₄₋ₘ in the form of a prepolymer. The prepolymer is a reaction product of the two components. These reactions are known and are also referred to as endcapping, as described, for example, in WO 2016/146648 A1.

“Tensile strength” is one of the mechanical properties of polymers that can be determined using various test methods. The “tensile strength” can be determined via the tensile stress at the moment of tearing of the test specimen in the tensile test.

“Elongation at break” is the ratio of the change in length to the initial length after the test specimen has broken. It expresses the ability of a material to withstand changes in shape without cracking. The elongation at break is determined according to DIN EN ISO 8339 and DIN 53504 in a tensile test.

“Elongation stress value” defines the stress that is exerted on the bonding surfaces or the adjacent building material when the sealant is 100% elongated.

“Secant modulus” is the ratio of stress to strain at any point on the curve of a stress-strain diagram. It is the gradient of a curve from the beginning to any point on the stress-strain curve.

“Resilience” describes the tendency of a flexible beam to fully or partially return to its original dimensions after the forces that caused the expansion or deformation have been removed. The average resilience is determined in accordance with DIN EN ISO 7389.

In a preferred embodiment of the invention, the curable composition comprises
(a) at least one compound of the formula HO—(SiR^{l}R^{m}O)ₒ—H, wherein R^{l} and R^{m} are as defined above and o is an integer from 5 to 5000,
(b) at least one crosslinker having the formula Si(R)ₘ(R^{a})₄₋ₘ, wherein
each R is independently an optionally substituted straight chain or branched C1 to C16 alkyl group, an optionally substituted straight chain or branched C2 to C16 alkenyl group, or an optionally substituted C4 to C14 aryl group,
m is an integer from 0 to 2,
each R^{a} is independently selected from the group consisting of
   a hydroxycarboxylic acid ester residue having the formula (I):

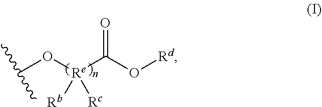

wherein
each R^{b} is independently H or an optionally substituted, straight-chain or branched C1 to C16 alkyl group or an optionally substituted C4 to C14 aryl group,
each R^{c} is independently H or an optionally substituted, straight-chain or branched C1 to C16 alkyl group or an optionally substituted C4 to C14 aryl group,
R^{d} is an optionally substituted, straight-chain or branched C1- to C16-alkyl group, an optionally substituted, straight-chain or branched C2- to C16-alkenyl or alkynyl group, an optionally substituted C4- to C14-cycloalkyl or cycloalkenyl group, an optionally substituted C5- to C15-aralkyl group or an optionally substituted C4- to C14-aryl group,
R^{e} is C or an optionally substituted saturated or partially unsaturated cyclic ring system having 4 to 14 C atoms or an optionally substituted aromatic group having 4 to 14 C atoms, and
n is an integer from 1 to 10,
   a hydroxycarboxylic acid amide residue having the formula (II):

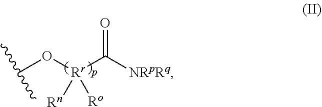

wherein
each Rⁿ is independently H or an optionally substituted, straight-chain or branched C1 to C16 alkyl group or an optionally substituted C4 to C14 aryl group,
each R^{o} is independently H or an optionally substituted, straight-chain or branched C1 to C16 alkyl group or an optionally substituted C4 to C14 aryl group,
R^{p} and R^{q} independently of one another are H or an optionally substituted, straight-chain or branched C1- to C16-alkyl group, an optionally substituted C4- to C14-cycloalkyl group, an optionally substituted C5- to C15-aralkyl group or an optionally substituted C4- to C14-aryl group,
R^{r} is C or an optionally substituted saturated or partially unsaturated cyclic ring system having 4 to 14 C atoms or an optionally substituted aromatic group having 4 to 14 C atoms, and
p is an integer from 1 to 10,
   a carboxylic acid residue —O—C(O)—R^{f}, wherein R^{f} is H or an optionally substituted, straight-chain or branched C1- to C16-alkyl group, an optionally substituted C4- to C14-cycloalkyl group or an optionally substituted C4- to C14-aryl group or an optionally substituted C5- to C15-aralkyl group,
   an oxime residue —O—N═CR^{g}R^{h}, wherein R^{g} and R^{h} independently of one another are H or an optionally substituted, straight-chain or branched C1- to C16-alkyl group, an optionally substituted C4 to C14-cycloalkyl group or an optionally substituted C4- to C14-aryl group or an optionally substituted C5- to C15-aralkyl group, and
   a carboxylic acid amide residue —N(Rⁱ)—C(O)—R^{j}, wherein Rⁱ is H or an optionally substituted, straight-chain or branched C1- to C16-alkyl group, an optionally substituted C4- to C14-cycloalkyl group or an optionally substituted C4- to C14-aryl group or an optionally substituted C5 to C15-aralkyl group, and R^{j} is H or an optionally substituted, straight-chain or branched C1- to C16-alkyl group, an optionally substituted C4- to C14-cycloalkyl group or an optionally substituted C4- to C14-aryl group or an optionally substituted C5- to C15-aralkyl group,
(c) a heterocyclic azasilane in which N and Si are ring atoms and are directly linked to each other, and
(d) an organophosphonic acid of the formula R—PO(OH)₂, wherein
R is
an optionally substituted alkyl, alkenyl or alkynyl residue,
an optionally substituted cycloaliphatic residue, aryl residue or aralkyl residue, or
an optionally substituted heteroalicyclic residue or heteroaryl residue.

The amount of organophosphonic acid, relative to the total amount of crosslinker, is preferably 0.3-30 mol %, particularly preferably 1-10 mol %, further preferably 3-8 mol % and most preferably 5-7 mol %.

The molar ratio of crosslinker to organophosphonic acid is preferably 3-350, more preferably 5-120 and most preferably 10-20. The amount of organophosphonic acid, based on the total amount of heterocyclic azasilanes, is preferably 1-30 mol %, more preferably 3-25 mol % and most preferably 8-18 mol %.

In the organophosphonic acid of the formula R—PO(OH)₂,
R preferably represents
an optionally substituted alkyl, alkenyl or alkynyl residue in each case having 2-12 carbon atoms,
an optionally substituted cycloaliphatic residue, aryl residue or aralkyl residue in each case having 6-12 carbon atoms, or an optionally substituted heteroalicyclic residue or heteroaryl residue in each case having 6-12 carbon atoms.

The organophosphonic acid is further preferably an alkylphosphonic acid, wherein the alkyl residue has 2-12 carbon atoms, preferably 4-10 carbon atoms, more preferably 6-9 carbon atoms and most preferably 8 carbon atoms. The alkyl residue may be substituted or unsubstituted, preferably unsubstituted, and/or it may be branched or unbranched, preferably it is unbranched. The organophosphonic acid is most preferably octylphosphonic acid, in particular n-octylphosphonic acid.

The compound of the formula HO—(SiR^{l}R^{m}O)ₒ—H is a silicone compound, also known as a polyorganosiloxane, wherein
each R^{l} and R^{m} independently represents
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
and o is an integer from 5 to 5000.

In a preferred embodiment, each R^{l} and R^{m} independently represents an optionally substituted, straight-chain or branched C1 to C16 alkyl group, an optionally substituted, straight-chain or branched C2 to C16 alkenyl group or an optionally substituted C4 to C14 aryl group.

In a further preferred embodiment, in the polyorganosiloxane HO—(SiR^{l}R^{m}O)ₒ—H o is an integer from 5 to 3500, more preferably from 10 to 3500, still more preferably from 100 to 3000, in particular from 800 to 2000, most preferably from 1000 to 1800.

In a further embodiment, the polyorganosiloxane HO—(SiR^{l}R^{m}O)ₒ—H has a weight average molecular weight M_{w} of from 400 to 5,000,000, in particular from 3,000 to 2,500,000, from 15,000 to 1,000,000, from 30,000 to 750,000, from 50,000 to 500,000 or from 110,000 to 150,000.

The composition also relates to a polyorganosiloxane HO—(SiR^{l}R^{m}O)ₒ—H, which has a kinematic viscosity of 20 to 500000 cSt at 25° C.

In a preferred embodiment, the one polyorganosiloxane HO—(SiR^{l}R^{m}O)ₒ—H has a kinematic viscosity of from 20 to 350000 cSt or from 20000 to 100000 cSt or from 20000 to 90000 cSt or from 20000 to 80000 cSt at 25° C.

In a further preferred embodiment, the composition contains polyorganosiloxanes HO—(SiR^{l}R^{m}O)ₒ—H, wherein R^{l} and R^{m} independently of one another contain an optionally substituted, straight-chain or branched C1- to C16-alkyl group, in particular an optionally substituted, straight-chain or branched C1- to C12- or C1- to C8-alkyl group, an optionally substituted, straight-chain or branched C2- to C16-alkenyl group, in particular an optionally substituted, straight-chain or branched C2- to C12- or C2- to C8-alkenyl group, or an optionally substituted C4- to C14-aryl group, in particular an optionally substituted C4- to C10-aryl group.

In a particularly preferred embodiment, the composition according to the invention comprises a polyorganosiloxane HO—(SiR^{l}R^{m}O)ₒ—H, wherein R^{l} and R^{m} are independently selected from the group consisting of methyl-, ethyl-, propyl-, butyl-, trifluoromethyl-, vinyl-, allyl-, butenyl-, phenyl- and—naphthyl-.

In a particularly preferred embodiment, the composition according to the invention comprises a polyorganosiloxane HO—(SiR^{l}R^{m}O)ₒ—H, wherein the polyorganosiloxane is α,ω-dihydroxy-dimethyl-polysiloxane.

Further, the composition according to the invention comprises crosslinkers of the formula Si(R)ₘ(R^{a})₄₋ₘ wherein each R^{a} is independently selected from the group consisting of:
a hydroxycarboxylic acid ester residue having the formula (I):

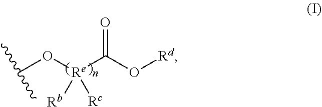

a hydroxycarboxylic acid amide residue having the formula (II):

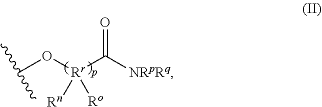

a carboxylic acid residue —O—C(O)—R^{f},
an oxime residue —O—N═CR^{g}R^{h},
a carboxylic acid amide residue —N(Rⁱ)—C(O)—R^{j},

In a preferred embodiment, the crosslinker comprises residues R of the formula Si(R)ₘ(R^{a})₄₋ₘ, wherein each residue R independently comprises an optionally substituted, straight-chain or branched C1- to C12-alkyl group, in particular an optionally substituted, straight-chain or branched C1- to C8-alkyl group, or an optionally substituted, straight-chain or branched C2- to C12-alkenyl group, in particular an optionally substituted, straight-chain or branched C2- to C8-alkenyl group, or an optionally substituted C4- to C10-aryl group.

In a particularly preferred embodiment, each residue R of the crosslinker of the formula Si(R)ₘ(R^{a})₄₋ₘ is independently a methyl, ethyl, propyl, vinyl-, phenyl or an allyl residue.

In a preferred embodiment, the composition according to the invention comprises crosslinkers of the formula Si(R)ₘ(R^{a})₄₋ₘ wherein each R^{a} is independently selected from the group consisting of:
a hydroxycarboxylic acid ester residue having the formula (I):

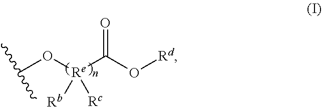

a hydroxycarboxylic acid amide residue having the formula (II):

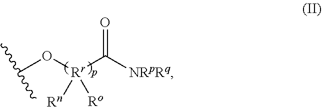

a carboxylic acid residue —O—C(O)—R^{f},
an oxime residue —O—N═CR^{g}R^{h},
a carboxylic acid amide residue —N(Rⁱ)—C(O)—R^{j},
wherein
each R^{b} is independently H or an optionally substituted, straight-chain or branched C1 to C16 alkyl group or an optionally substituted C4 to C14 aryl group,
each R^{c} is independently H or an optionally substituted, straight-chain or branched C1 to C16 alkyl group or an optionally substituted C4 to C14 aryl group,
R^{d} is an optionally substituted, straight-chain or branched C1 to C16 alkyl group, an optionally substituted, straight-chain or branched C2 to C16 alkenyl or alkynyl group, an optionally substituted C4 to C14 cycloalkyl or cycloalkenyl group, an optionally substituted C5 to C15 aralkyl group or an optionally substituted C4 to C14 aryl group,
R^{e} is C or an optionally substituted saturated or partially unsaturated cyclic ring system having 4 to 14 C atoms or an optionally substituted aromatic group having 4 to 14 C atoms, and
n is an integer from 1 to 10;
wherein
each Rⁿ is independently H or an optionally substituted, straight-chain or branched C1 to C16 alkyl group or an optionally substituted C4 to C14 aryl group,
each R^{o} is independently H or an optionally substituted, straight-chain or branched C1 to C16 alkyl group or an optionally substituted C4 to C14 aryl group,
R^{p} and R^{q} independently of one another are H or an optionally substituted, straight-chain or branched C1 to C16 alkyl group, an optionally substituted C4 to C14 cycloalkyl group, an optionally substituted C5 to C15 aralkyl group or an optionally substituted C4 to C14 aryl group,
R^{r} is C or an optionally substituted saturated or partially unsaturated cyclic ring system having 4 to 14 C atoms or an optionally substituted aromatic group having 4 to 14 C atoms, and
p is an integer from 1 to 10;
wherein
R^{f} is H or an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group;
wherein
R^{g} and R^{h} independently of one another are H or an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group;
and wherein
Rⁱ is H or an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group, and R^{j} is H or an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group.

In a preferred embodiment of the invention, the crosslinker comprises residues R, each R independently comprising an optionally substituted, straight-chain or branched C1 to C12 alkyl group, in particular an optionally substituted, straight-chain or branched C1 to C8 alkyl group, or an optionally substituted, straight-chain or branched C2 to C12 alkenyl group, in particular an optionally substituted, straight-chain or branched C2 to C8 alkenyl group, or an optionally substituted C4 to C10 aryl group.

In a particularly preferred embodiment, each residue R of the crosslinker of the formula Si(R)ₘ(R^{a})₄₋ₘ is independently a methyl, ethyl, propyl, vinyl-, phenyl or an allyl residue. In the hydroxycarboxylic acid ester residue of the crosslinker, each R^{b} and R^{c} is preferably independently of one another an optionally substituted, straight-chain or branched C1 to C12 alkyl group, in particular an optionally substituted, straight-chain or branched C1 to C8 alkyl group. The number n is preferably an integer from 1 to 5, in particular from 1 to 3, particularly preferably n=1.

In a preferred embodiment of the invention, in the hydroxycarboxylic acid ester residue of the crosslinker, each R^{b} and R^{c} is independently selected from the group consisting of H, methyl, ethyl, propyl, isopropyl, butyl, n-butyl, sec-butyl, iso-butyl and tert-butyl, in particular from the group consisting of H and methyl.

In the hydroxycarboxylic acid ester residue of the crosslinker, R^{d} is preferably an optionally substituted, straight-chain or branched C1 to C12 alkyl group, in particular an optionally substituted, straight-chain or branched C1 to C8 alkyl group, an optionally substituted straight-chain or branched C2 to C12 alkenyl or alkynyl group, in particular an optionally substituted, straight-chain or branched C2 to C18 alkenyl group, a C4 to C10 cycloalkyl group, a C5 to C11 aralkyl group or a C4 to C10 aryl group.

In a further preferred embodiment of the invention, the hydroxycarboxylic acid ester residue of the crosslinker R^{d} is selected from the group consisting of phenyl-, tolyl-, naphthyl-, benzyl-, cyclohexyl-, methyl-, ethyl-, propyl-, isopropyl-, butyl-, n-butyl-, sec-butyl-, iso-butyl-, tert-butyl-, pentyl-, n-pentyl-, sec-pentyl-, 3-pentyl-, 2-methylbutyl-, iso-pentyl-, 3-methylbut-2-yl-, 2-methylbut-2-yl-, neopentyl-, hexyl-, heptyl-, octyl-, ethylhexyl-, 2-ethylhexyl- and vinyl-. Methyl-, ethyl- and vinyl- are particularly preferred.

In a preferred embodiment, in the hydroxycarboxylic acid ester residue of the crosslinker, R^{e} is a divalent benzene residue, or R^{e} is C and R^{b} and R^{c} are H, or R^{e} is C and R^{b} is H and R^{c} is methyl—is present in the hydroxycarboxylic acid ester residue of the crosslinker R^{e}.

In a particularly preferred embodiment, R^{a} of the crosslinker is a hydroxycarboxylic acid ester residue and n is an integer from 1 to 5, particularly preferred is n=1 to 3, especially 1. Particularly preferred is the crosslinker methyl-tris(ethyl lactato)silane and/or tetra(ethyl lactato)silane.

In one embodiment, in the hydroxycarboxylic acid amide residue of the crosslinker in the composition according to the invention, each Rⁿ and R^{o} is independently H or an optionally substituted, straight-chain or branched C1 to C12 alkyl group, in particular an optionally substituted, straight-chain or branched C1 to C8 alkyl group.

In the hydroxycarboxylic acid amide residue of the crosslinker, each Rⁿ and R^{o} is preferably selected independently of one another from the group consisting of H, methyl, ethyl-, propyl, isopropyl, butyl, n-butyl, sec-butyl, iso-butyl and tert-butyl, in particular from the group consisting of H and methyl.

In a further embodiment, in the hydroxycarboxylic acid amide residue of the crosslinker R^{p} and R^{q} are independently H or an optionally substituted, straight-chain or branched C1 to C12 alkyl group, in particular an optionally substituted, straight-chain or branched C1 to C8 alkyl group, or an optionally substituted C4 to C14 cycloalkyl group or a C5 to C11 aralkyl group or a C4 to C10 aryl group.

In a preferred embodiment, in the hydroxycarboxylic acid amide residue of the crosslinker R^{p} and R^{q} are independently selected from the group consisting of H, phenyl, tolyl, naphthyl, benzyl, cyclohexyl, methyl, ethyl, propyl-, Isopropyl-, butyl-, n-butyl-, sec-butyl-, iso-butyl-, tert-butyl-, pentyl-, n-pentyl-, sec-pentyl-, 3-pentyl-, 2-methylbutyl-, iso-pentyl-, 3-methylbut-2-yl-, 2-methylbut-2-yl-, neopentyl-, hexyl-, heptyl-, octyl-, ethylhexyl-, and 2-ethylhexyl-.

In one embodiment, in the hydroxycarboxylic acid amide residue of the crosslinker, R^{r} is a divalent benzene residue, or R^{r} is C and Rⁿ and R^{o} are H, or R^{r} is C and Rⁿ is H and R^{o} is methyl—is present in the hydroxycarboxylic acid amide residue of the crosslinker R^{r}.

In a further preferred embodiment, p in the hydroxycarboxylic acid amide residue of the crosslinker is an integer from 1 to 5, in particular from 1 to 3, and p=1 is particularly preferred.

In the carboxylic acid residue of the crosslinker of the composition according to the invention, R^{f} is preferably H or an optionally substituted, straight-chain or branched C1 to C12 alkyl group, an optionally substituted C4 to C10 cycloalkyl group or an optionally substituted C4 to C10 aryl group or an optionally substituted C5 to C11 aralkyl group, in particular H or an optionally substituted, straight-chain or branched C1 to C8 alkyl group, an optionally substituted C4 to C8 cycloalkyl group or an optionally substituted C4 to C10 aryl group or an optionally substituted C5 to C11 aralkyl group.

In a preferred embodiment, the carboxylic acid residue of the crosslinker R^{f} is selected from the group consisting of H, phenyl-, tolyl-, naphthyl-, benzyl-, cyclohexyl-, methyl-, ethyl-, propyl- isopropyl-, butyl-, n-butyl-, sec-butyl-, iso-butyl-, tert-butyl-, pentyl-, n-pentyl-, sec-pentyl-, 3-pentyl-, 2-methylbutyl-, iso-pentyl-, 3-methylbut-2-yl-, 2-methylbut-2-yl-, neopentyl-, hexyl-, heptyl, octyl-, ethylhexyl-, and 2-ethylhexyl-. In a particularly preferred embodiment, the crosslinker with carboxylic acid residue is ethyltriacetoxysilane and/or methyltriacetoxysilane and/or propyltriacetoxysilane.

In a further preferred embodiment, in the oxime residue of the crosslinker according to the invention, R^{g} and R^{h} are independently H or an optionally substituted, straight-chain or branched C1 to C12 alkyl group, an optionally substituted C4 to C10 cycloalkyl group or an optionally substituted C4 to C10 aryl group or an optionally substituted C5 to C11 aralkyl group, in particular H or an optionally substituted, straight-chain or branched C1 to C8 alkyl group, an optionally substituted C4 to C8 cycloalkyl group or an optionally substituted C4 to C10 aryl group or an optionally substituted C5 to C11 aralkyl group.

In a preferred embodiment, in the oxime residue of the crosslinker R^{g} and R^{h} are independently selected from the group consisting of H, phenyl, tolyl, naphthyl, benzyl, cyclohexyl, methyl, ethyl, propyl, isopropyl, butyl-, n-butyl-, sec-butyl-, iso-butyl-, tert-butyl-, pentyl-, n-pentyl-, sec-pentyl-, 3-pentyl-, 2-methylbutyl-, iso-pentyl-, 3-methylbut-2-yl-, 2-methylbut-2-yl-, neopentyl-, hexyl-, heptyl-, octyl-, ethylhexyl- and 2-ethylhexyl-. In a particularly preferred embodiment, the crosslinker with oxime residue is methyl-tris(2-pentanonoximo)silane, vinyl-tris(2-pentanonoximo)silane and/or tetra(2-pentanonoximo)silane.

In a further preferred embodiment of the invention, in the carboxylic acid amide residue of the crosslinker according to the invention, Rⁱ and R^{j} are independently H or an optionally substituted, straight-chain or branched C1 to C12 alkyl group, an optionally substituted C4 to C10 cycloalkyl group or an optionally substituted C4 to C10 aryl group or an optionally substituted C5 to C11 aralkyl group, in particular H or an optionally substituted, straight-chain or branched C1 to C8 alkyl group, an optionally substituted C4 to C8 cycloalkyl group or an optionally substituted C4 to C10 aryl group or an optionally substituted C5 to C11 aralkyl group.

In the carboxylic acid amide residue of the crosslinker, Rⁱ and R^{j} are preferably selected independently of one another from the group consisting of H, phenyl-, tolyl-, naphthyl-, benzyl-, cyclohexyl-, methyl-, ethyl-, propyl-, isopropyl-, butyl-, n-butyl-, sec-butyl-, iso-butyl-, tert-butyl-, pentyl-, n-pentyl-, sec-pentyl-, 3-pentyl-, 2-methylbutyl-, iso-pentyl-, 3-methylbut-2-yl-, 2-methylbut-2-yl-, neopentyl-, hexyl-, heptyl-, octyl-, ethylhexyl-, and 2-ethylhexyl-. In a particularly preferred embodiment, the crosslinker with carboxylic acid amide residue is methyl ethoxy bis(N-methylbenzamido)silane.

In a further particularly preferred embodiment, mixtures of the crosslinkers described are used for the curable compositions according to the invention. In a further particularly preferred embodiment, the crosslinker carries various residues R^{a} as described above.

Furthermore, the composition according to the invention contains a heterocyclic azasilane which can function in the composition as an adhesion promoter, among other things. A mixture of several heterocyclic azasilanes can also be used.

In a preferred embodiment, the heterocyclic azasilane is a compound of the formula

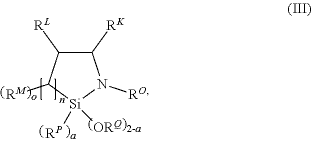

wherein
a=0, 1 or 2;
n=0-6;
each R^{K}, R^{L}, R^{M}, R^{O}, R^{P} and R^{Q} is independently H or an optionally substituted straight-chain or branched C1 to C20 alkyl group, an optionally substituted straight-chain or branched C2 to C20 alkenyl group, an optionally substituted C3 to C20 cycloalkyl group, an optionally substituted C4 to C20 cycloalkenyl group, an optionally substituted straight-chain branched or cyclic C4 to C20 alkynyl group or an optionally substituted, straight-chain or branched C2 to C20 heteroalkyl group, an optionally substituted, straight-chain branched or cyclic C3 to C20 heteroalkenyl group or an optionally substituted C4 to C14 aryl or heteroaryl group, or two residues R^{K}, R^{L}, R^{M}, R^{O}, R^{P} and R^{Q} together form a 5- to 8-membered ring.

The parameter a in (R^{P})ₐ and (OR^{Q})₂₋ₐ represents a ratio of alkoxy residues OR^{Q} to residues R^{P} as defined herein. Here, a can assume values from 0 to 2. If a=0, the corresponding heterocyclic organosilane contains no residue R^{P} and two OR^{Q} residues. The parameter a can also be 1. In this case, one R^{P} residue and one OR^{Q} residue are directly bound to the silicon atom of the heterocyclic organosilane. If a=2, only R^{P} residues and no OR^{Q} residues are linked to the silicon atom.

The residues (R^{M})ₙ in formula (III) are each directly related to the ring size, which is determined by the parameter n. The possible number of residues on the ring atoms is also adjusted here by the value n. For example, if there is a 6 ring, n=2 and the number of residues R^{c} or R^{C} is adjusted accordingly to 2. This means that each ring atom can have one residue.

The heterocyclic azasilane can carry different residues on each ring atom, each R^{K}, R^{L}, R^{M}, R^{O}, R^{P} and R^{Q} of formula (III) is independently of one another H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight-chain, branched or cyclic C4 to C20 alkynyl group or an optionally substituted, straight-chain or branched C2 to C20 heteroalkyl group, an optionally substituted, straight-chain, branched or cyclic C3 to C20 heteroalkenyl group or an optionally substituted C4 to C14 aryl or heteroaryl group. Preferably, each R^{K}, R^{L}, R^{M}, R^{O}, R^{P} and R^{Q} is independently H, or an optionally substituted straight-chain or branched C1 to C10 alkyl group, an optionally substituted straight-chain or branched C2 to C10 alkenyl group, an optionally substituted straight-chain or branched C2 to C10 heteroalkyl group, an optionally substituted C3 to C10 cycloalkyl group, or an optionally substituted C4 to C8 aryl or heteroaryl group. Most preferably, each R^{K}, R^{L}, R^{M}, R^{O}, R^{P} and R^{Q} is independently H, an optionally substituted straight or branched C1 to C8 alkyl group, an optionally substituted straight or branched C2 to C8 alkenyl group, an optionally substituted straight or branched chain C4 to C8 heteroalkyl group, an optionally substituted C4 to C6 cycloalkyl group or an optionally substituted C5 to C6 aryl or heteroaryl group.
n is preferably 1-4, further preferred 1-2, in particular 1.

In a preferred embodiment of the invention, the heterocyclic azasilane has the following structural formula:

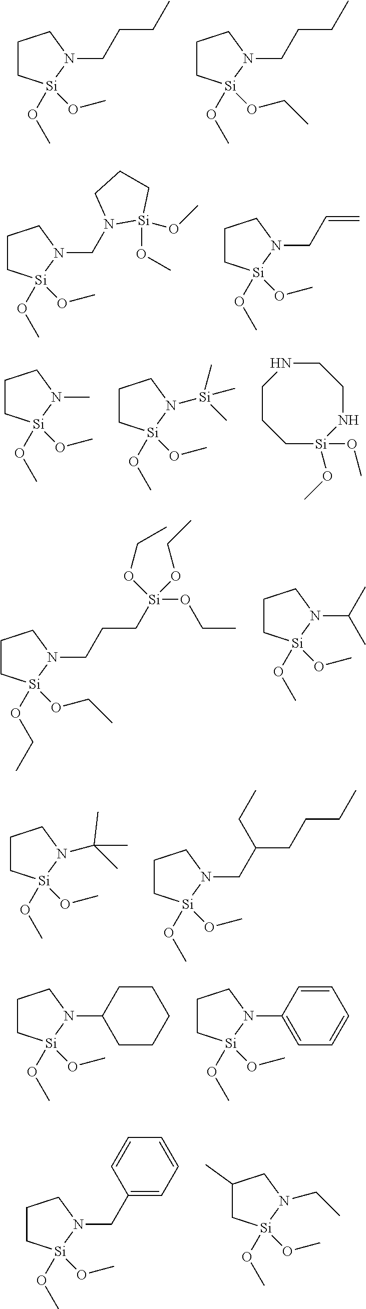

The composition according to the invention may contain one or more of the compounds shown above (heterocyclic azasilanes).

Particularly preferred heterocyclic azasilanes are substituted or unsubstituted, in particular unsubstituted, N-n-butyl-1-aza-2,2-dimethoxy-2-silacyclopentane ((BDC), CAS No. 618914-44-6), 2,2-diethoxy-1-(3-triethoxysilylpropyl)aza-2-silacyclopentane ((TESPDC), CAS No. 1184179-50-7) and/or 2,2-diethoxy-1-(trimethylsilyl)aza-2-silacyclopentane ((TMS)DEC), CAS No. 21297-72-3)

In a preferred embodiment, the composition according to the invention contains the heterocyclic azasilane in an amount, based on the total weight of the composition, of 0.1-3 wt. %, preferably 0.2-2 wt. %, particularly preferably 0.3-1.5 wt. %.

The composition according to the invention preferably additionally contains a metal catalyst in order to accelerate the curing of the composition according to the invention. Particularly preferably, the composition according to the invention contains a metal catalyst which does not contain tin. These catalysts have the advantage that toxic tin is avoided. They solve the problem of the invention of avoiding toxic components of the composition, in particular toxic tin. Surprisingly, it was found in the context of the invention that a curable composition with the advantages of increased storage stability can be provided by the combination of containing heterocyclic azasilane and organophosphonic acid in the presence of polyorganosiloxane and crosslinker even with tin-free catalysts in the mixture, and yet rapid crosslinking occurs, although tin-containing catalysts are particularly effective catalysts in these silicone rubber compounds. In this way, the advantages of increased storage stability could be combined with the low toxicity of tin-free catalysts, while at the same time maintaining the other advantageous properties of the curable compositions.

Preferably, the metal of the metal catalyst is selected from the group consisting of Na, Zn, Sc, Nd, Ti, Zr, Hf, V, Fe, Pt, Cu, Ga, and Bi, more preferably selected from the group consisting of Zn, Ti, Zr, Hf, V, Fe, and Bi. Most preferred is the metal of the metal catalyst Zr.

In a preferred embodiment of the invention, the composition comprises as metal catalyst a metal siloxane, in particular a metal siloxane of the formula R*_{A}Si_{B}O_{C}M_{D}, wherein each R* is independently selected from the group consisting of optionally substituted C1 to C20 alkyl, optionally substituted C3 to C6 cycloalkyl, optionally substituted C2 to C20 alkenyl, optionally substituted C6 to C10 aryl, —OH and —O—(C1 to C20 alkyl), wherein
M is the metal,
A is an integer from 4 to 19,
B is an integer from 4 to 10,
C is an integer from 8 to 30, and
D is an integer from 1 to 8.

The metal siloxane is preferably a metal silsesquioxane, in particular a polyhedral metal silsesquioxane. A polyhedral metal silsesquioxane is understood to be a metal silsesquioxane in which silicon and metal atoms at least partially occupy the corners of a polyhedron, for example a cube.

The metal silsesquioxane is particularly preferably a polyhedral titanium and/or zirconium silsesquioxane, especially a zirconium silsesquioxane.

In a preferred embodiment, the metal siloxane, preferably the metal silsesquioxane, has the following formula (IV)

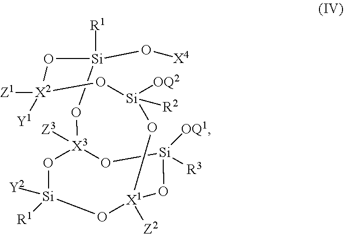

wherein X¹, X² and X³ are independently selected from Si or M¹, wherein M¹ is a metal, preferably not tin, in particular selected from the group consisting of Na, Zn, Sc, Nd, Ti, Zr, Hf, V, Fe, Pt, Cu, Ga and Bi; in particular preferably from the group consisting of Zn, Ti, Zr, Hf, V, Fe and Bi,
Z¹, Z² and Z³ are independently selected from the group consisting of L², R⁵, R⁶ and R⁷, wherein L² is selected from the group consisting of —OH and —O—(C1 to C10 alkyl), in particular —O—(C1 to C8 alkyl) or —O—(C1 to C6 alkyl), or wherein L² is selected from the group consisting of —OH, —O-methyl, —O-ethyl, —O-propyl, —O-butyl, —O-octyl, —O-isopropyl, and —O-isobutyl;
R¹, R², R³, R⁴, R⁵, R⁶ and R⁷ are independently selected from the group consisting of optionally substituted C1 to C20 alkyl, optionally substituted C3 to C8 cycloalkyl, optionally substituted C2 to C20 alkenyl and optionally substituted C5 to C10 aryl;
Y¹ and Y² are independently —O-M²-L³_{Δ}, or Y¹ and Y² are taken together and together are —O-M²(L³_{Δ})-O—or —O—, wherein L³ is selected from the group consisting of —OH and —O—(C1 to C10 alkyl), in particular —O—(C1 to C8 alkyl) or —O—(C1 to C6 alkyl), or wherein L³ is selected from the group consisting of —OH, —O-methyl, —O-ethyl, —O-propyl, —O-butyl, —O-octyl, —O-isopropyl, and —O-isobutyl, and wherein M² is a metal, preferably not tin, more preferably a metal selected from the group consisting of Na, Zn, Sc, Nd, Ti, Zr, Hf, V, Fe, Pt, Cu, Ga and Bi; in particular preferably from the group consisting of Zn, Ti, Zr, Hf, V, Fe, Bi,
and X⁴ is −M³L¹_{Δ} or M³ and Q¹ and Q² are each H or a single bond linked to M³, wherein L¹ is selected from the group consisting of —OH and —O—(C1 to C10 alkyl), in particular —O—(C1 to C8 alkyl) or —O—(C1 to C6 alkyl), or wherein L¹ is selected from the group consisting of —OH, —O-methyl, —O-ethyl, —O-propyl, —O-butyl, —O-octyl, —O-isopropyl, and —O-isobutyl, and wherein M³ is a metal, preferably not tin, more preferably a metal selected from the group consisting of Na, Zn, Sc, Nd, Ti, Zr, Hf, V, Fe, Pt, Cu, Ga and Bi; in particular preferably from the group consisting of Zn, Ti, Zr, Hf, V, Fe, Bi,
or
X⁴ is −M³L¹ and Q² is H or a single bond linked to M³ and Q¹ is H, M⁴L⁴_{Δ} or —SiR⁸, wherein M⁴ is a metal, preferably not tin, more preferably a metal selected from the group consisting of Na, Zn, Sc, Nd, Ti, Zr, Hf, V, Fe, Pt, Cu, Ga and Bi; in particular preferably from the group consisting of Zn, Ti, Zr, Hf, V, Fe and Bi, and wherein L⁴ is selected from the group consisting of —OH and —O—(C1 to C10 alkyl), in particular —O—(C1 to C8 alkyl) or —O—(C1 to C6 alkyl), or wherein L⁴ is selected from the group consisting of —OH, —O-methyl, —O-ethyl, —O-propyl, —O-butyl, —O-octyl, —O-isopropyl, and —O-isobutyl, and wherein R⁸ is selected from the group consisting of optionally substituted C1 to C20 alkyl, optionally substituted C3 to C6 cycloalkyl, optionally substituted C2 to C20 alkenyl and optionally substituted C6 to C10 aryl,
or
X⁴, Q¹ and Q² are independently of one another −M³L¹_{Δ},
or
X⁴ is —Si(R⁸)—O-M³L¹_{Δ}, Q² is a single bond linked to the Si atom of X⁴ and Q¹ is −M⁴L⁴_{Δ},
or
X⁴ is —Si(R⁸)—O-M³L¹_{Δ}, Q² is a single bond linked to the Si atom of X⁴ and Q¹ is a single bond linked to the M³ atom of X⁴.

In a particularly preferred embodiment, the metal silsesquioxane has the structural formula (V)

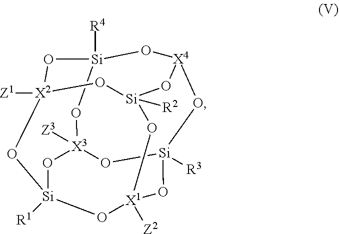

wherein X¹, X² and X³ are independently selected from Si or M¹, wherein M¹ is a metal, preferably not tin, more preferably a metal selected from the group consisting of Na, Zn, Sc, Nd, Ti, Zr, Hf, V, Fe, Pt, Cu, Ga and Bi; more preferably from the group consisting of Zn, Ti, Zr, Hf, V, Fe and Bi,
Z¹, Z² and Z³ are independently selected from the group consisting of L², R⁵, R⁶ and R⁷, wherein L² is selected from the group consisting of —OH and —O—(C1 to C10 alkyl), in particular —O—(C1 to C8 alkyl) or —O—(C1 to C6 alkyl), or wherein L² is selected from the group consisting of —OH, —O-methyl, —O-ethyl, —O-propyl, —O-butyl, —O-octyl, —O-isopropyl, and —O-isobutyl;
R¹, R², R³, R⁴, R⁵, R⁶ and R⁷ are independently selected from the group consisting of optionally substituted C1 to C20 alkyl, optionally substituted C3 to C8 cycloalkyl, optionally substituted C2 to C20 alkenyl and optionally substituted C5 to C10 aryl;
wherein X⁴ is −M³L¹_{Δ}, wherein L¹ is selected from the group consisting of —OH and —O—(C1 to C10 alkyl), in particular —O—(C1 to C8 alkyl) or —O—(C1 to C6 alkyl), or wherein L¹ is selected from the group consisting of —OH, —O-methyl, —O-ethyl, —O-propyl, —O-butyl, —O-octyl, —O-isopropyl, and —O-isobutyl, and wherein M³ is a metal, preferably not tin, more preferably a metal selected from the group consisting of Na, Zn, Sc, Nd, Ti, Zr, Hf, V, Fe, Pt, Cu, Ga and Bi; in particular preferably from the group consisting of Zn, Ti, Zr, Hf, V, Fe and Bi.

In another particularly preferred embodiment, the metal silsesquioxane has the formula (VI)

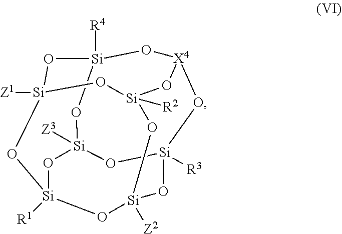

wherein X⁴ is −M³L¹_{Δ}, wherein L¹ is selected from the group consisting of —OH and —O—(C1 to C10 alkyl), in particular —O—(C1 to C8 alkyl) or —O—(C1 to C6 alkyl), or wherein L¹ is selected from the group consisting of —OH, —O-methyl, —O-ethyl, —O-propyl, —O-butyl, —O-octyl, —O-isopropyl, and —O-isobutyl, and wherein M³ is a metal, preferably not tin, more preferably a metal selected from the group consisting of Na, Zn, Sc, Nd, Ti, Zr, Hf, V, Fe, Pt, Cu, Ga and Bi; in particular preferably from the group consisting of Zn, Ti, Zr, Hf, V, Fe and Bi,
Z¹, Z² and Z³ are independently selected from the group consisting of optionally substituted C1 to C20 alkyl, optionally substituted C3 to C8 cycloalkyl, optionally substituted C2 to C20 alkenyl and optionally substituted C5 to C10 aryl;
R¹, R², R³ and R⁴ are each independently selected from the group consisting of optionally substituted C1 to C20 alkyl, optionally substituted C3 to C8 cycloalkyl, optionally substituted C2 to C20 alkenyl and optionally substituted C5 to C10 aryl.

Particularly preferred in the above formulae is X⁴=ZrOR or TiOR, especially ZrOR, with R=C1 to C12 alkyl, especially ZrO-methyl, ZR—O-ethyl, ZR—O-propyl, ZR—O-butyl, ZR—O-octyl, ZR—O-isopropyl, ZR—O-isobutyl, ZR—O-butyl.

In a particularly preferred embodiment, the metal silsesquioxane has the structure (VII)

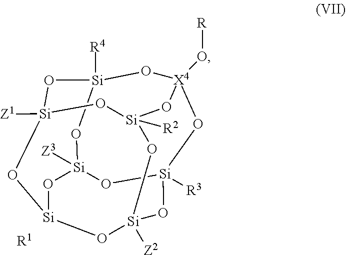

wherein Zr is linked to OR, wherein R is selected from the group consisting of —H, -methyl, -ethyl, -propyl, -butyl, -octyl, -isopropyl, and -isobutyl,
Z¹, Z² and Z³ are each independently of one another C1 to C20 alkyl, C3 to C8 cycloalkyl, C2 to C20 alkenyl and C5 to C10 aryl, in particular are selected from the group consisting of methyl, ethyl, propyl, isopropyl, butyl, isobutyl, hexyl, heptyl, octyl, vinyl, allyl, butenyl and phenyl, and benzyl, and
R¹, R², R³ and R⁴ are each independently of one another C1 to C20 alkyl, C3 to C8 cycloalkyl, C2 to C20 alkenyl and C5 to C10 aryl, in particular selected from the group consisting of methyl, ethyl, propyl, isopropyl, butyl, isobutyl, hexyl, heptyl, octyl, vinyl, allyl, butenyl and phenyl, and benzyl.

The weight ratio of the polyorganosiloxane (a), in particular the α,ω-dihydroxyl-terminated polydialkylsiloxane, to the crosslinker is preferably 100:1-2:1, particularly preferably 50:1 to 5:1, especially 15:1-6:1.

In addition to the components described, the composition according to the invention may optionally contain further ingredients/components, in particular conventional additives such as fillers, plasticizers, reactive diluents, colorants, thixotropic agents, rheological additives, wetting agents, UV stabilizers, antioxidants, drying agents, etc. Preferably, the curable compositions according to the invention contain at least one further component.

The composition according to the invention may preferably contain plasticizers. Preferred plasticizers are end-capped polyethylene glycols, e.g. polyethylene or polypropylene glycol dialkyl ethers, wherein the alkyl residue has one to four C atoms, in particular dimethyl and diethyl ethers of diethylene glycol and dipropylene glycol. Preferred plasticizers are also diurethanes, which can be produced, for example, by reacting diols with OH end groups with monofunctional isocyanates. In a preferred embodiment of the invention, polyalkylsiloxanes, particularly preferably polydimethylsiloxane, are used as plasticizers.

The curable compositions preferably contain plasticizers in an amount of 2 to 50 wt. %, preferably in an amount of 10 to 40 wt. %, particularly preferably in an amount of 20 to 35 wt. %, in each case based on the total weight of the composition. If a mixture of several plasticizers is used, the quantities given refer to the total amount of plasticizer in the composition.

If the viscosity of the curable composition is to be reduced, reactive diluents can also be added. Suitable reactive diluents are compounds that are miscible with the composition and have at least one group that is reactive with the polymer. Preferably, the reactive diluent has at least one functional group that reacts with moisture or atmospheric oxygen. Examples are isocyanate groups, silyl groups or unsaturated groups such as vinyl groups. To produce preferred reactive diluents, corresponding polyol components, for example, can be reacted with an at least difunctional isocyanate.

The composition according to the invention may further contain fillers. Suitable fillers include chalk, lime powder, precipitated and/or fumed silica, zeolites, bentonites, magnesium carbonate, alumina, tallow, titanium oxide, iron oxide, zinc oxide, quartz, sand, mica and other powdered or ground mineral substances. Furthermore, organic fillers can also be used, in particular wood fibers, wood flour, sawdust, cellulose, cotton, chaff.

In a particularly preferred embodiment of the invention, silica is added to the composition as a filler, in untreated and/or treated, preferably hydrophobized form, particularly preferably fumed silica, also referred to as fumed silicon dioxide. In a particularly preferred embodiment of the invention, a mixture of untreated and hydrophobized silica is added to the curable composition as a filler.

The fillers are preferably used in an amount of 1 to 60 wt. %, particularly preferably 2 to 20 wt. %, and very particularly preferably 5 to 15 wt. %, in each case based on the total weight of the composition. Mixtures of several fillers can also be used. In this case, the quantities given refer to the total amount of filler in the composition.

For some applications, additives or fillers that impart thixotropy to the preparations are preferred. Such fillers are also described as rheological aids, e.g. hydrogenated castor oil, fatty acid amides or swellable plastics.

In addition to the heterocyclic azasilane, the composition according to the invention may contain additional adhesion promoters. Suitable adhesion promoters here are, for example, resins, e.g. aliphatic or petrochemical resins and modified phenolic resins as well as terpene oligomers. Such resins are used, for example, as adhesion promoters for pressure-sensitive adhesives and coating materials. Terpene-phenol resins are also suitable.

Preferably, the curable composition contains at least one stabilizer selected from the group consisting of antioxidants, UV stabilizers and desiccants. Antioxidants are preferably present up to about 6 wt. %, in particular up to about 4 wt. %. In the context of the present invention, it is preferred if a UV stabilizer is used which carries a silyl group and is polymerized into the product during crosslinking or curing.

The composition according to the invention can also be stabilized against penetrating moisture by desiccants in order to further increase the storability. All compounds that react with water to form an inert group with respect to the reactive groups present in the preparation are suitable as desiccants. Suitable desiccants include isocyanates and silanes, for example vinyl silanes such as 3-vinylpropyltriethoxysilane, oximo silanes or carbamatosilanes. However, the use of methyl, ethyl or vinyl trimethoxysilane, tetramethyl or ethyl ethoxysilane is also possible. Vinyltrimethoxysilane and tetraethoxysilane are particularly preferred.

In a preferred embodiment of the invention, the components of the composition are mixed together, in particular in the form of a single-phase mixture.

The invention also relates to a process for preparing the curable composition according to the invention, wherein components (a) to (d), and optionally other components, are mixed together.

The invention also relates to the use of the curable composition according to the invention, in particular as a sealant, glue, coating agent, jointing material, casting compound, adhesive and/or in paints.

It is understood that the above-mentioned features and the features to be explained below can be used not only in the combinations indicated, but also in other combinations or on their own, without going beyond the scope of the present invention. The aforementioned advantages of features or of combinations of several features are merely exemplary and can take effect alternatively or cumulatively. The combination of features of different embodiments of the invention or of features of different patent claims is possible in deviation from the selected references of the patent claims.

The following examples further explain the invention without limiting the invention thereto.

### EXAMPLES

### Example 1

A silicone rubber compound is produced according to the following formulation: 570 g alpha-omega hydroxyl-terminated polydimethylsiloxane with a viscosity of 80,000 cSt
270 g polydimethylsiloxane with viscosity 100 cSt
50 g highly dispersed silica untreated
50 g highly dispersed silica hydrophobized
Mixture of 40.7 g methyl-tris(ethyl lactato)silane and 8.7 g tetraethyl lactatosilane
12.0 g adhesion promoter butyldimethoxycyclosilane (BDC, N-n-butyl-1-aza-2,2-dimethoxy-2-silacyclopentane)
0.5 g catalyst iBu-POSS—Zr-OEt
1.5 g octylphosphonic acid

The sealant has been exposed to air after application:
a skin formation time of 5 min
a bonding time of 35 min
early stress after 180 min
complete curing after 24 hours
a transparent appearance
a Shore hardness A of 18
good adhesion to wood, painted wood, varnished wood, aluminum, powder-coated aluminum, glass, PVC, polyamide, steel, concrete, etc.

The sealant is also characterized by its excellent storage stability.

After 8 weeks of storage at 50° C. in the cartridge, the sealant still has the same properties as when it was first applied.

### Example 2

A silicone rubber compound is produced according to the following formulation:
570 g alpha-omega hydroxyl-terminated polydimethylsiloxane with a viscosity of 80,000 cSt
270 g polydimethylsiloxane with viscosity 100 cSt
50 g highly dispersed silica untreated
50 g highly dispersed silica hydrophobized
49.4 g methyl-tris(ethyl lactato)silane
12.0 g adhesion promoter butyldimethoxycyclosilane (BDC, N-n-butyl-1-aza-2,2-dimethoxy-2-silacyclopentane)
1.0 g catalyst iBu-POSS—Zr-OEt
1.5 g octylphosphonic acid

The sealant has been exposed to air after application:
a skin formation time of 11 min
a bonding time of 65 min
an early stress after 280 min
complete curing after 24 hours
a transparent appearance
a Shore hardness A of 17
good adhesion to wood, painted wood, varnished wood, aluminum, powder-coated aluminum, glass, PVC, polyamide, steel, concrete, etc.

The sealant is also characterized by its excellent storage stability.

After 8 weeks of storage at 50° C. in the cartridge, the sealant still has the same properties as when it was first applied.

For detailed examination and comparison with an established silicone sealant, the following example 3 and the comparative example were examined in detail.

### Example 3

Analogous to examples 1 and 2, a silicone rubber compound was prepared according to the following formulation:

| | Fabric | Weight % |
|---|---|---|
| 1 | Polymer 80,000 cSt | 57.1 |
| | (α-ω-dihydroxy-dimethyl-polysiloxane) | |
| 2 | Plasticizer 100 cSt | 26.45 |
| | (polydimethylsiloxane) | |
| 3 | Crosslinker 1: | 3.6 |
| | (methyl-tris(ethyl lactato)silane) | |
| 4 | Crosslinker 2: | 1.4 |
| | (tetra(ethyl lactato)silane) | |
| 5 | Pyrogenic silica, hydrophobic | 5.0 |
| | (BET surface area 130-150 m²/g) | |
| 6 | Pyrogenic silica, untreated | 5.0 |
| | (BET surface area 130-150 m²/g) | |
| 7 | Adhesion promoter: BnDC | 1.2 |
| | (benzyldimethoxycyclosilane, N-benzyl-1-aza-2,2- | |
| | dimethoxy-2-silacyclopentane) | |
| 8 | Catalyst: iBu—POSS—Zr—OEt | 0.1 |
| 9 | Stabilizer octylphosphonic acid | 0.15 |

### Comparative Example (Prior Art)

| | Component | Weight % |
|---|---|---|
| 1 | a,ω-dihydroxy-dimethyl-polysiloxane | 52.1 |
| | 80,000 cSt | |
| 2 | Polydimethylsiloxane (PDMS) 100 cSt | 32.9 |
| 3 | Crosslinker 1: Vinyl-tris(ethyl lactato)silane | 2.5 |
| 4 | Crosslinker 2: Methyl-tris(ethyl lactato)silane | 2.5 |
| 5 | Aminopropyltriethoxysilane (AMEO) | 0.2 |
| 6 | Pyrogenic silica, untreated | 8.5 |
| | BET surface area 130-150 m²/g | |
| 7 | Catalyst 1:1 (w/w) Mixture of dialkylzine oxide and | 0.1 |
| | tetraalkoxysilane | |
| 8 | Adhesion promoter: N-n-butyl-1-aza-2,2-dimethoxy-2- | 1.2 |
| | silacyclopentane (BDC) (BDC) | |

The optical properties of the compositions from examples 1 to 3 and the comparative example were comparable on application, as were the mechanical properties after curing. However, the silicone rubber compounds according to examples 1 to 3 were found to have improved storage stability and adhesion compared to the reference example. The composition according to examples 1 to 3 was still colorless after storage at 50° C. after eight weeks, whereas the composition of the comparative example was yellowish after eight weeks at 50′° C. In terms of adhesion, the composition according to examples 1 to 3 exhibited improved adhesion to Plexiglas, polycarbonate and polystyrene compared to the comparative example. An additional advantage of the above examples according to the invention is that toxic tin could be dispensed with.

Compared to the sealant of the above comparative example, the above examples show that the mechanical properties of the compositions according to the invention are equally good compared to known silicone rubber compounds and at the same time the storage stability and adhesion to plastics such as Plexiglas, polycarbonate or polystyrene could be improved.

1.-15. (canceled)

16. A curable composition, comprising
(a) a polyorganosiloxane of the formula HO—(SiR^{l}R^{m}O)ₒ—H, wherein
each R^{l} and R^{m} independently represents
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
and o is an integer from 5 to 5000,
(b) a crosslinker of the formula Si(R)ₘ(R^{a})₄₋ₘ, wherein
each R independently represents
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
m is an integer from 0 to 2;
each R^{a} is independently selected from the group consisting of
(b1) a hydroxycarboxylic acid ester residue of the formula (I): 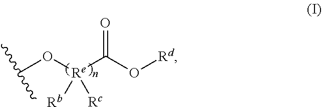
wherein
each R^{b} and R^{c} independently of each other represents
hydrogen;
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
each R^{d} independently represents
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
each R^{e} independently represents
carbon;
an optionally substituted cycloaliphatic residue, aryl residue or aralkyl residue; or
an optionally substituted heteroalicyclic residue or heteroaryl residue;
and n is an integer from 1 to 10,
(b2) a hydroxycarboxamide residue of the formula (II): 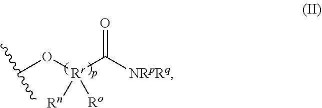
wherein
each Rⁿ, R^{o}, R^{p} and R^{q} independently of one each other represents
hydrogen;
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
R^{r} independently of each other represents
carbon;
an optionally substituted cycloaliphatic residue, aryl residue or aralkyl residue; or
an optionally substituted heteroalicyclic residue or heteroaryl residue;
and p is an integer from 1 to 10,
(b3) a carboxylic acid residue —O—C(O)—R^{f},
(b4) an oxime residue —O—N═CR^{g}R^{h}, and
(b5) to a carboxylic acid amide residue —N(Rⁱ)—C(O)—R^{j},
wherein each R^{f}, R^{g}, R^{h}, Rⁱ and R^{j} independently of one each other represents
hydrogen;
an optionally substituted alkyl, alkenyl or alkynyl residue;
an optionally substituted cycloaliphatic residue, aryl residue or aralkyl residue; or
an optionally substituted heteroalicyclic residue or heteroaryl residue;
(c) a heterocyclic azasilane in which N and Si are ring atoms and are directly linked to each other; and
(d) an organophosphonic acid of the formula R—PO(OH)₂, wherein
R is
an optionally substituted alkyl, alkenyl or alkynyl residue;
an optionally substituted cycloaliphatic residue, aryl residue or aralkyl residue, or
an optionally substituted heteroalicyclic residue or heteroaryl residue.

17. The composition according to claim 16, wherein the amount of organophosphonic acid, based on the total amount of crosslinker, is 0.3-30 mol %.

18. The composition according to claim 17, wherein the amount of organophosphonic acid, based on the total amount of crosslinker, is 1-10 mol %.

19. The composition according to claim 16, wherein the organophosphonic acid is an alkylphosphonic acid having 2 to 12 carbon atoms.

20. The composition according to claim 19, wherein the organophosphonic acid is an octylphosphonic acid.

21. The composition according to claim 16, further comprising:
a metal catalyst.

22. The composition according to claim 21, wherein the metal catalyst does not contain tin.

23. The composition according to claim 21, wherein the metal of the metal catalyst is selected from the group consisting of Na, Zn, Sc, Nd, Ti, Zr, Hf, V, Fe, Pt, Cu, Ga, and Bi.

24. The composition according to claim 21, wherein the metal of the metal catalyst is selected from the group consisting of Zn, Ti, Zr, Hf, V, Fe and Bi.

25. The composition according to claim 21, wherein the metal of the metal catalyst is Zr.

26. The composition according to claim 21, wherein the metal catalyst is a metal siloxane of the formula
R*_{A}Si_{B}O_{C}M_{D}, wherein
each R* is independently selected from the group consisting of optionally substituted C1 to C20 alkyl, optionally substituted C3 to C6 cycloalkyl, optionally substituted C2 to C20 alkenyl, optionally substituted C6 to C10 aryl, —OH and —O—(C1 to C20 alkyl),
M is the metal,
A is an integer from 4 to 19,
B is an integer from 4 to 10,
C is an integer from 8 to 30, and
D is an integer from 1 to 8.

27. The composition according to claim 26, wherein the metal siloxane is a polyhedral metal silsesquioxane.

28. The composition according to claim 27, wherein the metal siloxane is a polyhedral titanium and/or zirconium silsesquioxane.

29. The composition according to claim 16, wherein the crosslinker each R^{a} is independently selected from the group consisting of
(b1) a hydroxycarboxylic acid ester residue of formula (I) wherein the residues are as defined in claim 16, and
(b2) a hydroxycarboxylic acid amide residue of formula (II) wherein the residues are as defined in claim 16.

30. The composition according to 16, wherein the crosslinker R^{a} is a hydroxycarboxylic acid ester residue of the formula (I), and wherein n=1.

31. The composition according to claim 16, wherein the heterocyclic azasilane is a compound of the formula 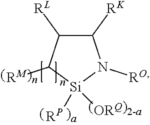
wherein
a=0, 1 or 2;
n=0-6;
each R^{K}, R^{L}, R^{M}, R^{O}, R^{P} and R^{Q} is independently H or an optionally substituted straight-chain or branched C1 to C20 alkyl group, an optionally substituted straight-chain or branched C2 to C20 alkenyl group, an optionally substituted C3 to C20 cycloalkyl group, an optionally substituted C4 to C20 cycloalkenyl group, an optionally substituted straight-chain, branched or cyclic C4 to C20 alkynyl group or an optionally substituted, straight-chain or branched C2 to C20 heteroalkyl group, an optionally substituted, straight-chain, branched or cyclic C3 to C20 heteroalkenyl group or an optionally substituted C4 to C14 aryl or heteroaryl group, or two residues R^{K}, R^{L}, R^{M}, R^{O}, R^{P} and R^{Q} together form a 5- to 8-membered ring.

32. The composition according to claim 16, wherein the heterocyclic azasilane is N-n-butyl-1-aza-2,2-dimethoxy-2-silacyclopentane, 2,2-diethoxy-1-(3-triethoxysilylpropyl)aza-2-silacyclopentane and/or 2,2-diethoxy-1-(trimethylsilyl)aza-2-silacyclopentane, preferably N-n-butyl-1-aza-2,2-dimethoxy-2-silacyclopentane.

33. The composition according to claim 16, wherein the polyorganosiloxane is polydimethylsiloxane.

34. A process for preparing a curable composition according to claim 16, wherein the components (a) to (d) are mixed.

35. A use of a curable composition according to claim 16 as a sealant, glue, coating agent, jointing material, potting compound, adhesive or in paints.
